(19) United States
(12) Patent Application Publication
(10) Pub. No.: US 2010/0104941 A1
(43) Pub. Date: Apr. 29, 2010

(54) GASKET, ENCLOSED SECONDARY BATTERY AND ELECTROLYTIC CAPACITOR

(76) Inventor: Makoto Nakabayashi, Sennan-gun (JP)

Correspondence Address: MCDERMOTT WILL & EMERY LLP, 600 13TH STREET, N.W., WASHINGTON, DC, 20005-3096, US

(21) Appl. No.: 12/442,907

(22) PCT Filed: Oct. 2, 2007
(86) PCT No.: PCT/JP2007/069286

§ 371 Date: Mar. 25, 2009

(30) Foreign Application Priority Data
Oct. 6, 2006 (JP) 2006-275440

(51) Int. Cl. H01M 2/08; F16J 15/10; H01G 9/10

(52) U.S. Cl. 429/181; 277/650; 361/519

(57) ABSTRACT

A gasket that can exhibit good heat resistance (in particular, instantaneous heat resistance), good electrolyte resistance and insulating property, and good sealing property while achieving size and thickness reduction, an enclosed secondary battery including the gasket, and an electrolytic capacitor including the gasket are achieved.

The enclosed secondary battery includes a battery element 15 that includes a positive plate 11, a negative plate 12, and two separators 13 and 14 interposed between the positive plate 11 and the negative plate 12; a sealing body (positive electrode terminal) 17 electrically connected to the positive plate 11; a negative electrode terminal 18 electrically connected to the negative plate 12; and a gasket 19 for insulating the positive electrode terminal from the negative electrode terminal. The gasket 19 is a gasket containing a cross-linked ionomer and is bonded onto the positive electrode terminal or the negative electrode terminal 18 by applying heat and pressure.

### TECHNICAL FIELD

The present invention relates to a gasket for use in an enclosed secondary battery or an electrolytic capacitor, an enclosed secondary battery using the gasket, and an electrolytic capacitor using the gasket.

### BACKGROUND ART

Enclosed secondary batteries such as lithium-ion secondary batteries have been widely known as examples of power sources for portable electronic devices such as portable telephones, personal digital assistances (PDAs), etc.

An enclosed secondary battery, in general, includes a battery element that contains a electrode plate group including a positive plate, a negative plate, and a separator interposed between the positive plate and the negative plate, and an electrolyte in which the electrode plate group is immersed. The battery element is housed in a battery case (exterior body) having an opening and sealed with a sealing body that seals the opening of the battery case.

The enclosed secondary battery has a gasket disposed at, for example, a contact point between a positive electrode terminal electrically connected to the positive plate and a negative electrode terminal electrically connected to the negative plate to prevent a short-circuit between the pair of terminals and leakage of the electrolyte.

The gasket is required to exhibit resistance to the electrolyte (electrolyte resistance) and a good sealing property and insulating property as well as good heat resistance to withstand overheating caused by overcharging of the enclosed secondary battery and instantaneous heating during laser-welding of the battery case to the sealing body.

Patent Document 1 describes a gasket for use in an enclosed secondary battery. This gasket is an insulating gasket composed of a radiation crosslinked resin having a residual elastic modulus of 4.0% or more. Examples of the radiation crosslinked resin disclosed include polyolefin resins, polyolefin elastomers, polyethylene terephthalate resin, polyester elastomers, polyphenylene sulfide resin, polyarylate resin, polyamide resin, polyamide elastomers, fluorine resin, and fluorine elastomers.

[Patent Document 1] Japanese Unexamined Patent Application Publication No. 2005-310569

### DISCLOSURE OF INVENTION

### Problems to be Solved by the Invention

According to the insulating gasket described in Patent Document 1, a resin is converted into a three-dimensional structure by radiation cross-linking to raise the temperature at which the structure can maintain its shape (shape retention temperature) while allowing the resin to maintain a particular level or more of residual elastic modulus and maintain resilience.

However, in making smaller, thinner gaskets that meet the recent demand for smaller and thinner enclosed secondary batteries, the absolute amount of allowance for gasket compressive deformation (amount of deformation caused by compression) decreases and thus the sealing property of the gaskets may be lowered.

Furthermore, size and thickness reduction of a gasket is likely to degrade the heat resistance of the gasket. In particular, the heat resistance against instantaneous heating (instantaneous heat resistance) for laser-welding a battery case to a sealing body will notably decrease as the size and thickness of the gasket are reduced, frequently resulting in problems such as heat deformation of the gasket and electrolyte leakage caused by heat deformation.

Electrolytic capacitors having a structure similar to that of enclosed secondary batteries may also face the problem of degradation of the sealing property of gaskets caused by size and thickness reduction of electrolytic capacitors.

An object of the present invention is to provide a gasket that has good heat resistance (in particular, instantaneous heat resistance) and insulating properties and that can exhibit a good sealing property despite small size and thickness, an enclosed secondary battery using the gasket, and an electrolytic capacitor using the gasket.

### Means for Solving the Problems

In aiming to achieve the above-described object, a gasket of the present invention contains a cross-linked ionomer.

This gasket not only has good electrolyte resistance and insulating property, but also exhibits a higher shape retention temperature while maintaining the resilience. In other words, heat resistance can be improved while maintaining the sealing property of the gasket. Moreover, instantaneous heat resistance can also be improved.

The ionomer has high adhesion to a metal (e.g., aluminum) that forms an exterior body of a battery case of an enclosed secondary or an electrolytic capacitor. The metal and gasket can be tightly bonded to each other by bonding a gasket composed of a cross-linked ionomer under heat and pressure.

Thus, for example, when the gasket of the present invention is bonded, under heat and pressure, to a battery case which also serves as a positive electrode terminal of an enclosed secondary battery, or to an exterior body of an electrolytic capacitor, the gasket can absorb the heat cycle and deformation caused by thermal expansion and shrinkage of the battery case or the exterior body. A good sealing property can be exhibited even when the absolute amount of allowance for compression deformation of the gasket decreases as a result of size and thickness reduction of the enclosed secondary battery or the electrolytic capacitor.

The ionomer contained in the gasket of the present invention is preferably a polyolefin series ionomer or a fluorine series ionomer.

When the ionomer is a polyolefin series ionomer, the resilience and heat resistance (shape retention) can hit a proper balance after crosslinking.

When the ionomer is a fluorine series ionomer, the durability of the gasket is improved, and the gasket becomes more suitable for use at high temperature.

For the gasket of the present invention, the tensile storage elastic modulus F measured at a temperature of 350° C. and a frequency of 10 Hz is preferably 1 MPa or more and a peel strength when press-bonded to a surface of a metal plate at 200° C. to 400° C. and 0.1 to 10 MPa is preferably 0.1 N/15 mm or more.

According to such a gasket, since the tensile storage elastic modulus E′ at a temperature as high as 350° C. is sufficiently high, good resilience is offered in a high temperature range.

Moreover, since the debonding strength to the metal surface is sufficiently high, adhesion to the metal plate is high and the gasket can absorb deformation caused by thermal expansion and shrinkage of the metal plate. Furthermore, for example, in sealing between a positive electrode terminal and a negative electrode terminal composed of metal plates in the enclosed secondary battery or in sealing between an exterior body and a sealing body composed of metal plates in the electrolytic capacitor, the sealing property can be improved.

An enclosed secondary battery of the present invention includes a battery element that includes a positive plate, a negative plate, and a separator interposed between the positive plate and the negative plate, a positive electrode terminal electrically connected to the positive plate, a negative electrode terminal electrically connected to the negative plate, and a gasket for insulating the positive electrode terminal from the negative electrode terminal, in which the gasket is the gasket of the present invention and is bonded onto the positive electrode terminal or the negative electrode terminal by applying heat and pressure.

According to this enclosed secondary battery, since the gasket of the present invention is used as a gasket for sealing and insulation between the positive electrode terminal and the negative electrode terminal, the sealing property and the insulating property between the positive electrode terminal and the negative electrode terminal are significantly enhanced. Furthermore, a good sealing property is offered by the gasket even when the size and thickness of the gasket is reduced due to the size and thickness reduction of the enclosed secondary battery.

Furthermore, according to the enclosed secondary battery described above, since the gasket is bonded to the positive or negative terminal by applying heat and pressure, the positive terminal and the negative terminal can be sealed to and insulated from each other even when the residual elastic modulus of the gasket is low, e.g., less than 4.0% (refer to Patent Document 1), thereby preventing leakage of the electrolyte.

In this enclosed secondary battery, for example, when an exterior body for housing a battery element is laser-welded to a sealing body for sealing an opening of the exterior body by a common procedure, the gasket interposed between the sealing body and the negative electrode terminal is instantaneously heated as the exterior body and the sealing body are instantaneously heated. However, since the gasket of the present invention has good resistance to instantaneous heating (instantaneous heat resistance), heat deformation of the gasket and electrolyte leakage caused by the heat deformation can be prevented.

The electrolytic capacitor of the present invention includes a capacitor element that includes a positive electrode foil, a negative electrode foil, and a separator interposed between the positive electrode foil and the negative electrode foil, an exterior body having an opening for housing the capacitor element, a sealing body for sealing the opening of the exterior body, and a gasket for sealing between the exterior body and the sealing body, in which the gasket is the gasket of the present invention and is bonded onto any one of an inner surface of the exterior body and a surface of the sealing body by applying heat and pressure.

According to this electrolytic capacitor including the gasket of the present invention to seal between the exterior body and the sealing body, the sealing property between the exterior body and the sealing body is notably improved.

Furthermore, a good sealing property is offered by the gasket even when the size and thickness of the gasket is reduced due to the size and thickness reduction of the electrolytic capacitor.

Advantages

According to a gasket of the present invention, an enclosed secondary battery using the gasket, and an electrolytic capacitor using the gasket, good heat resistance (in particular, instantaneous heat resistance), high electrolyte resistance, and good insulating property can be exhibited due to the use of gasket. Moreover, a good sealing property can be offered even when the size and thickness are reduced.

According to the present invention, further size and thickness reduction of the enclosed secondary battery and the electrolytic capacitor can be realized.

### BRIEF DESCRIPTION OF DRAWINGS

FIG. 1 is a partial cut-away perspective view showing one embodiment of an enclosed secondary battery of the present invention.

FIG. 2 is a partial cut-away view showing another embodiment of the enclosed secondary battery of the present invention.

FIG. 3 is a cross-sectional view showing yet another embodiment of the enclosed secondary battery of the present invention.

FIG. 4 is a partial cut-away perspective view showing one embodiment of the electrolytic capacitor of the present invention.

FIG. 5 Part (a) to Part (c) of FIG. 5 is a schematic diagram illustrating the process of measuring the residual elastic modulus of a gasket.

### REFERENCE NUMERALS

10, 30, 50: enclosed secondary battery
11, 31, 51: positive plate
12, 32, 52: negative plate
13, 14, 33, 34, 53, 54, 73, 74: separator
17, 37: sealing body (positive electrode terminal)
18: negative electrode terminal
19, 38, 57, 78: gasket
36: battery case (negative electrode terminal)
55: battery case (positive electrode terminal)
56: sealing body (negative electrode terminal)
70: electrolytic capacitor
71: positive electrode foil
72: negative electrode foil
79: positive electrode terminal
81: negative electrode terminal

### BEST MODES FOR CARRYING OUT THE INVENTION

A gasket of the present invention contains a cross-linked ionomer.

An ionomer is a polymer constituted by high-molecular-weight molecules (ionomer molecules) that contain a constitutional unit having an ionic functional group and/or an ionizable group.

Examples of the ionic functional group include a carboxyl group and a sulfo group.

Examples of the constitutional unit (hereinafter referred to as “ionic monomer”) having the ionic functional group and/or the ionizable group include carboxyl-containing monomer units such as acrylic acid (1-carboxyethylene unit), methacrylic acid (1-methyl-1-carboxyethylene unit), styrene carboxylic acid (1-carboxyphenylethylene unit), and maleic acid (1,2-dicarboxyethylene unit); and sulfo-containing monomer units such as ethylene sulfonic acid (1-sulfoethylene unit), styrene sulfonic acid (1-sulfophenylethylene unit), and sulfobenzenedicarboxylic acid alkylene unit represented by the formula below:

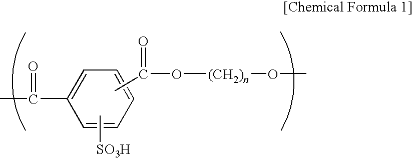

(in the formula, n represents an integer of 1 to 6.)

Examples of the sulfobenzenedicarboxylic acid alkylene unit represented by the formula above include sulfoterephthalic acid ethylene unit, sulfoisophthalic acid ethylene unit, and the like.

The ionic functional group of the ionic monomer may form a salt but does not have to form a salt. When the ionic functional group is a carboxyl group, the carboxyl group may exist as an anhydride of a dicarboxylic acid.

The salt is formed by substituting at least one dissociable hydrogen ion in the ionic monomer with a cation, for example, an alkali metal ion (such as Na⁺ or Li⁺), an alkaline earth metal ion (such as Mg²⁺ or Ca²⁺), a zinc ion (Zn²⁺), an aluminum ion (Al³⁺), an ammonium ion (NH⁴⁺), or a phosphonium ion (PH⁴⁺). In particular, the salt preferably has a dissociable hydrogen ion in the ionic monomer, substituted with a zinc ion to decrease the water absorption property of the ionomer.

In the case where the ionomer is a copolymer that contains an ionic monomer and a monomer unit other than the ionic monomer, the monomer unit may be, for example, an olefin (e.g., ethylene or propylene), a styrene (1-phenyl ethylene unit), a styrene derivative (e.g. p-methylstyrene (1-(p-tolyl)ethylene unit), or the like), a benzene dicarboxylic acid alkylene (e.g., terephthalic acid ethylene (ethylene terephthalate unit), isophthalic acid ethylene (ethylene isophthalate unit), terephthalic acid butylene (butylene terephthalate unit), isophthalic acid butylene (butylene isophthalate unit), or the like), an acrylic acid monoalkyl ester (e.g., acrylic acid monoethyl (ethyl acrylate unit) or the like), a methacrylic acid alkyl ester (e.g., methacrylic acid monomethyl (methyl methacrylate unit) or the like), or a fluorinated olefin (e.g., 1,1,-difluoroethylene (i.e., monomer unit of polyvinylidene fluoride), perfluoroethylene, perfluoropropylene, or the like). These monomer units of the copolymer of the ionic monomer and the monomer unit may be used alone or in combination.

Among the examples of the monomer units described above, preferred are ethylene, styrene, ethylene terephthalate, ethylene isophthalate, and tetrafluoroethylene.

Examples of the ionomer include polyolefin series ionomers, fluorine series ionomers, polystyrene series ionomers, polyester series ionomers, and (meth)acrylic series ionomers. In the ionomers described below, dissociable hydrogen ions in the ionic monomer may be substituted with the cations described above to form salts.

An example of the polyolefin ionomer is an ionomer that contains an olefin as the monomer unit and acrylic acid, methacrylic acid, maleic acid, or ethylene sulfonic acid as the ionic monomer. A dicarboxylic acid such as maleic acid may be an anhydride. Examples thereof include, but are not particularly limited to, an ethylene-acrylic acid copolymer and an ethylene-methacrylic acid copolymer.

An example of the fluorine series ionomer is an ionomer that contains a fluorinated olefin alone or in combination with an olefin as the monomer unit and a maleic acid as the ionic monomer. Examples thereof include, but are not particularly limited to, polyvinylidene fluoride (PVDF) and an ethylene tetrafluoride-ethylene copolymer (ETFE) modified with an ionic monomer such as maleic anhydride, for example.

The polystyrene series ionomer may be as follows:

(i) an ionomer that contains, for example, a styrene or a styrene derivative as the monomer unit and acrylic acid, methacrylic acid, styrene-carboxylic acid, or styrene sulfonic acid as the ionic monomer; or

(ii) an ionomer that contains, for example, an olefin as the monomer unit and styrene carboxylic acid or styrene sulfonic acid as the ionic monomer.

Examples of (i) above include, but are not limited to, a styrene-styrene sulfonic acid copolymer, a styrene-acrylic acid copolymer, a styrene-methacrylic acid copolymer, a styrene-styrene carboxylic acid copolymer, and a styrene-ethylene sulfonic acid copolymer. Examples of (ii) above include, but are not limited to, an ethylene-styrene carboxylic acid copolymer and an ethylene-styrene sulfonic acid copolymer.

The polyester series ionomer may be as follows:

(iii) an ionomer that contains a benzene dicarboxylic acid alkylene as the monomer unit and a sulfobenzenedicarboxylic acid alkylene, acrylic acid, methacrylic acid, styrene carboxylic acid, ethylene sulfonic acid, styrene sulfonic acid, or the like as the ionic monomer; or

(iv) an ionomer that contains, for example, an olefin, a styrene, a styrene derivative, an acrylic acid monoalkyl ester, or a methacrylic acid monoalkyl ester as the monomer unit and a sulfobenzenedicarboxylic acid alkylene as the ionic monomer.

Examples of (iii) include, but are not limited to, a copolymer of ethylene terephthalate and ethylene sulfoterephthalate, a copolymer of ethylene isophthalate and ethylene sulfoisophthalate, and a copolymer of butylene terephthalate and ethylene sulfoterephthalate. Examples of (iv) include, but are not limited to, a copolymer of ethylene and ethylene sulfoterephthalate and a copolymer of ethylene and ethylene sulfoisophthalate.

The (meth)acryl series ionomer may be as follows:

(v) an ionomer that contains, for example, an acrylic acid monoalkyl ester or a methacrylic acid monoalkyl ester as the monomer unit and acrylic acid or methacrylic acid as the ionic monomer; or

(vi) an ionomer that contains, for example, an olefin as the monomer unit and acrylic acid or methacrylic acid as the ionic monomer.

Examples of (v) include, but are not limited to, an ethyl acrylate-acrylic acid copolymer, an ethyl acrylate-methacrylic acid copolymer, a methyl methacrylate-acrylic acid copolymer, and a methyl methacrylate-methacrylic acid copolymer.

Other examples of the ionomer include, for example, a styrene-(N-methyl-4-vinylpyridinium salt) copolymer.

The ionomer is particularly preferably a polyolefin series ionomer among the examples described above from the viewpoints of the cross-linking property of the ionomer and high availability. The polyolefin series ionomer having an ethylene group (—CH₂CH₂—) in the molecule has good radiation cross-linking property. Thus, the gasket after cross-linking maintains resilience of the resin and exhibits higher shape retention temperature, while thermal deformation of the gasket is suppressed.

The ionomer is particularly preferably a fluorine series ionomer among those examples described above from the viewpoints of durability and properties of use under high temperature. A gasket formed of a fluorine series ionomer has improved long-term heat resistance and is suitable for use in high temperature environment.

The weight-average molecular weight of the ionomer is not particularly limited but is preferably 500 to 5,000,000 and more preferably 1000 to 1,000,000 when determined by gel permeation chromatography (GPC) (polystyrene standard, eluent: tetrahydrofuran (THF)). An ionomer having a weight-average molecular weight over 5,000,000 is extremely difficult to synthesize or acquire. An ionomer having a weight-average molecular weight less than 500 may not achieve sufficient mechanical strength even after cross-linking, and thus the gasket may become highly brittle.

The copolymerization ratio of the ionic monomer in the ionomer is not particularly limited but preferably 20 mol % or less, more preferably 1 to 20 mol %, and most preferably 1 to 16 mol % in terms of the content ratio (mol %) of the ionic monomer units relative to all monomer units in the ionomer. The copolymerization ratio of the ionic monomer is determined as a product of the molar ratio of the ionic monomer in the ionomer and 100.

When the copolymerization ratio of the ionic monomer is 20 mol % or less, the resilience and the heat resistance (shape retention) are well balanced after cross-linking of the ionomer. When the copolymerization ratio of the ionic monomer is less than 1 mol %, the cross-linking property of the ionomer may decrease and the heat resistance may be lowered (heat deformation may readily occur). In contrast, at a copolymerization ratio exceeding 20 mol %, the cross-linking property of the ionomer increases and the resilience after cross-linking may be degraded.

The degree of neutralization of the ionomer greatly varies with the type of the monomer units constituting the ionomer and the type of cation constituting the salt, and is thus not limited. In general, the degree of neutralization is preferably 5 to 60%. The degree of neutralization is a ratio of conversion of ionic functional groups contained in the ionic monomer to salts.

At a degree of neutralization of 5 to 60%, the gas barrier property and hygroscopicity resistance can be properly balanced. At a degree of neutralization below 5%, although the hygroscopicity resistance may improve, the gas barrier property may be degraded.

At a degree of neutralization exceeding 60%, although the gas barrier property may improve, the hygroscopicity resistance may be degraded.

The ionomer is commercially available. Examples of the commercially available products include “HIMILAN (registered trademark)” series (ionomer resin) and “NUCREL (registered trademark)” series (ethylene-methacrylic acid copolymer) produced by DU PONT-MITSUI POLYCHEMICALS CO., LTD., and “ADMER (registered trademark)” series (modified polyolefin containing a carboxyl group or a dicarboxylic anhydride as the functional group introduced in a polyolefin) produced by MITSUI CHEMICALS, INC.

Examples of the fluorine series ionomer include “NAFION (registered trademark)” series (perfluorosulfonic acid-tetrafluoroethylene copolymer) produced by E. I. du Pont de Nemours and Company, and “NEOFLON ETFE” series (ethylene tetrafluoride-ethylene copolymer (ETFE)) produced by DAIKIN INDUSTRIES, LTD., modified with maleic acid.

The ionomer can be cross-linked by radiation cross-linking, chemical cross-linking, silane cross-linking, or the like. Preferably, the ionomer is radiation cross-linked.

Examples of the radiation cross-linking include electron beam cross-linking, α-ray cross-linking, γ-ray cross-linking, β-ray cross-linking, and neutron cross-linking. Of these, electron beam cross-linking is industrially preferable.

The conditions for radiation cross-linking are not particularly limited since they are adequately set according to the type of radiation, thickness of the gasket, or the like. Preferably, in general, the radiation dose is 10 to 1000 kGy and more preferably 100 to 500 kGy.

If the radiation dose for the gasket is excessively large, the resilience of the gasket may be degraded. If the radiation dose is excessively small, the heat resistance, in particular, the instantaneous heat resistance, of the gasket may decrease.

An example of chemical cross-linking is a peroxide cross-linking that uses a peroxide as a cross-linker.

Examples of the peroxide that serves as a cross-linker include dicumylperoxide and 2,5-dimethyl-2,5-di(tert-butylperoxy)hexane (e.g., “PERHEXA (registered trademark) 25B” produced by Nippon Oil & Fats Co., Ltd).

The gasket may contain another polymer in addition to the ionomer.

Examples of the polymer include a polyolefin, a polyester, a polyurea, a polycarbonate, a polyurethane, a polyacryl, a fluorine resin, a fluorine elastomer, a polyolefin series elastomer, polyphenylene sulfide (PPS), and polyether ether ketone (PEEK). A polyolefin is preferred.

Examples of the polyolefin include polyethylene, polypropylene, an ethylene-ethyl acrylate copolymer (EEA), an ethylene-vinyl acetate copolymer (EVA), and a polycyclic olefin. Among these, polyethylene is preferred, and high-density polyethylene is more preferred.

Note that the polymer described above preferably has good compatibility with the ionomer. From this standpoint, a polyolefin is usually used. For example, when a polyester series ionomer is used, the polymer is preferably a polyester, more preferably, polyethylene terephthalate, polybutylene terephthalate, polyethylene naphthalate, or the like.

The ionomer content in the polymer components constituting the gasket is preferably 20 to 100 percent by weight, more preferably 50 to 100 percent by weight, and most preferably 70 to 100 percent by weight relative to the total weight of the polymer components constituting the gasket. At an ionomer content less than 20 percent by weight, the desired effects of the present invention may not be achieved.

The gasket may further contain cross-linking auxiliaries.

Examples of the cross-linking auxiliaries include triallyl isocyanate (TAIC), diallyl isocyanate, di(meth)acryl isocyanate, tri(meth)acryl isocyanurate, 1,4-butanediol di(meth)acrylate, polyethylene glycol di(meth)acrylate, pentaerythritol di(meth)acrylate, dipentaerythritol hexaacrylate, trimethylolpropane acrylate, divinylbenzene, trivinylbenzene, and hexamethylbenzene. Of these, TAIC is preferred.

The cross-linking property between the molecules of the ionomer or between the ionomer and a blended component such as another polymer can be improved by adding cross-linking auxiliaries. For example, when the cross-linking auxiliaries are contained, ionic functional groups in a side chain of the ionomer can form crosslinks with compounds having a variety of reactive functional groups or can form bonds with the main chain (in particular, the methylene moiety in the main chain) of another molecule of the ionomer. Thus, the mechanical strength and other properties of the gasket can be improved through these crosslinks or bonds. For example, in cross-linking the ionomer through radiation cross-linking, addition of cross-linking auxiliaries will decrease the radiation dose while increasing the cross-linking density.

Examples of the cross-linking structure formed by the cross-linking auxiliaries include ester bonds formed by reactions between carboxyl groups and hydroxyl groups and amide bonds formed by reactions between carboxyl groups and amino groups for an ionomer containing carboxyl groups as the ionic functional groups. For an ionomer containing sulfo groups as the ionic functional groups, sulfonamide bonds are formed by reactions between sulfo groups and amino groups.

The cross-linking auxiliary is an optional component, and thus its content is not particularly limited. For example, the cross-linking auxiliary content is preferably 10 parts by weight or less per 100 parts by weight of the ionomer.

The gasket may further contain a filler.

Examples of the filler include silica, kaolin, clay, organized clay, talc, mica, alumina, calcium carbonate, calcium terephthalate, titanium oxide, calcium phosphate, calcium fluoride, lithium fluoride, cross-linked polystyrene, and potassium titanate. Among these, silica is preferred. The filler is preferably mixed in microparticle form.

When a gasket contains a filler such as silica, deformation and hardness degradation of the gasket, especially the gasket under a high-temperature condition, can be suppressed.

The amount of filler mixed is not particularly limited, but, for example, is preferably 1 to 100 parts by weight and more preferably 10 to 50 parts by weight per 100 parts by weight of the polymer components constituting the gasket.

The gasket may be formed by mixing a polymer, a cross-linking auxiliary, and a filler to the ionomer and extruding the resulting mixture with a twin-screw extruder or the like as necessary to form a material having a desired shape, and then subjecting the material to cross-linking.

Alternatively, a gasket may be formed by adding an acetyl acetone metal complex, a metal oxide, a fatty acid metal salt, or the like to a metal-ion-free copolymer of ethylene and acrylic or methacrylic acid to introduce ionic crosslinks into the copolymer and subjecting the resulting product to a shape forming process.

A resin which is a metal ion-free ethylene-acrylic acid copolymer and which can be converted into an ionomer by a shape forming process is commercially available. One example of the commercial product is “YUKARON EAA” (trade name, presently known as REXPEARL by Japan Polyethylene Corporation) produced by Mitsubishi Chemical Corporation.

The gasket preferably has a tensile storage elastic modulus E′ of 1×10⁶ Pa or more when measured at a temperature of 350° C. and a frequency of 10 Hz.

If the tensile storage elastic modulus E′ under the above-described conditions is in the described range, the gasket can exhibit sufficient rubber resilience even in a high-temperature condition as high as 350° C. Thus, by setting the tensile storage elastic modulus E′ under the above-described condition in the described range, good sealing property and heat resistance can be imparted to the gasket of the present invention.

The peel strength of the gasket when pressure-bonded onto a surface of a metal plate at 1 to 10 MPa at 200° C. to 300° C. is preferably 10 N/15 mm or more.

When the peel strength to the surface of the metal plate is within the above-described range, the gasket can absorb deformation caused by thermal expansion and shrinkage of the metal plate. Thus, for example, when the gasket is interposed between the metal plate and another component, sealing between the metal plate and another component can be achieved through not only compressive deformation of the gasket between the metal plate and the component, but also adhesion between the metal plate and the gasket. Thus, size and thickness reduction of gasket can be achieved.

The metal plate for determining the peel strength is preferably, but not limited to, an aluminum plate. When the metal plate is an aluminum plate and the peel strength under the condition described above satisfies the range described above, the gasket can absorb deformation caused by thermal expansion and shrinkage of the aluminum plate.

The volume resistivity ρ of the gasket is preferably 1×10⁸ Ωcm or more for the gasket to exhibit good insulating property.

The gasket of the present invention not only has good electrolyte resistance and insulating properties but also good sealing property and high heat resistance (in particular, instantaneous heat resistance), as described above. Thus the gasket is suitable for use as a gasket interposed between a positive electrode terminal and a negative electrode terminal of an enclosed secondary battery to insulate the two terminals, prevent a short-circuit, and prevent electrolyte leakage. For example, the gasket is suitable as a gasket interposed between an exterior body and a sealing body of an electrolytic capacitor to seal the exterior body and the sealing body and to prevent leakage of the electrolyte.

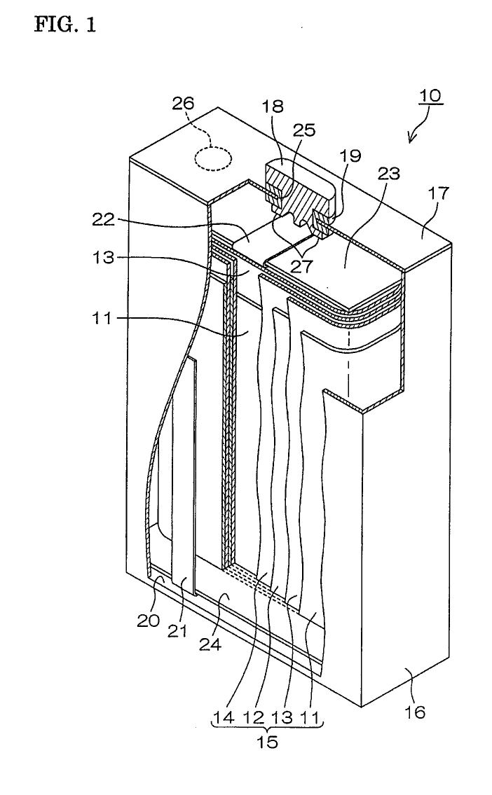

FIG. 1 is a partial cut-away perspective view showing one embodiment of the enclosed secondary battery of the present invention.

In FIG. 1, an enclosed secondary battery 10 is a prismatic enclosed secondary battery and includes a battery element 15 including a electrode plate group having a positive plate 11, a negative plate 12, and two separators 13 and 14 interposed between these plates and an electrolyte (not shown) in which the electrode plate group is immersed; a battery case 16 that houses the battery element 15 and is electrically connected to the positive plate 11; a sealing body 17 that seals the opening of the battery case 16 and is electrically connected to the battery case 16; a negative electrode terminal 18 that is electrically connected to the negative plate 12 and extends from the interior of the battery case 16 to the exterior of the battery case 16 through a through hole in the sealing body 17; and a gasket 19 interposed between the negative electrode terminal 18 and the sealing body 17 to insulate the negative electrode terminal 18 from the sealing body 17.

As shown by partial cut-away view of FIG. 1, in the battery element 15, the electrode plate group that includes the positive plate 11, the negative plate 12, and the two separators 13 and 14 is formed by stacking the positive plate 11 and the negative plate 12 with the separator 13 therebetween, stacking the separator 14 on the negative plate 12-side surface to obtain a multilayer structure, rolling up the multilayer structure with the positive plate 11 facing out and the separator 14 facing in, and pressing the resulting roll so that it spreads into a substantially rectangular shape in a top view.

The positive plate 11 has one or two positive active material layers formed by applying a positive electrode paste on one or both sides of a positive electrode collector and drying and flattening the applied paste. A portion of the positive plate 11 exposed at the outermost surface of the battery element 15 is formed as a plain part where no positive active material layer is provided. A positive electrode lead 21 for electrically connecting the positive plate 11 to a bottom 20 of the battery case 16 is welded to this plain part.

Examples of the material forming the positive electrode collector include aluminum, an aluminum alloy, and copper. The thickness of the positive electrode collector is not particularly limited but is, preferably about 10 to 60 μm.

The surface of the positive electrode collector may be subjected to lath working or etching treatment.

The positive electrode paste is prepared by blending and mixing a positive active material, a binder, a dispersant, and, if necessary, a conductant agent, a thickener, or the like.

The positive active material is not particularly limited. An example thereof is a lithium-containing transition metal compound that can accept lithium ions as guests. Specific examples thereof include a complex metal oxide of lithium and at least one transition metal selected from the group consisting of cobalt, manganese, nickel, chromium, iron, and vanadium, a transition metal chalcogenide, a lithide of a vanadium oxide, and a lithide of a niobium oxide.

Examples of the complex metal oxide of lithium and the transition metal include complex metal oxides represented by LiCoO₂, LiMnO₂, LiNiO₂, LiCrO₂, αLiFeO₂, LiVO₂, LiₓCo_{y}Ni_{1-y}O₂, LiₓCo_{y}M_{1-y}O_{z}, LiNi_{1-y}M_{y}O_{z}, LiMn₂O₄, and LiₓMn_{2-y}M_{y}O₄ (where M is at least one element selected from the group consisting of Na, Mg, Sc, Y, Mn, Fe, Co, Ni, Cu, Zn, Al, Cr, Pb, Sb, and B, x is 0 to 1.2, y is 0 to 0.9, and z is 2.0 to 2.3). Note that x in the above-described formulae increases or decreases with discharging and charging operations.

These positive active materials may be used alone or in combination. The average particle diameter of the positive electrode material is not particularly limited but is preferably about 1 to 30 μm.

The binder, conductant agent, thickener, and dispersant of the positive electrode paste may be those known in the art.

To be more specific, the binder may be any binder that can be dissolved or dispersed in a dispersant of the paste, e.g., a fluorine series binder, acrylic rubber, modified acrylic rubber, styrene-butadiene rubber (SBR), an acrylic series polymer, and a vinyl series polymers. These binders may be used alone or in combination. The fluorine series binder is preferably polyvinylidene fluoride, a copolymer of vinylidene fluoride and propylene hexafluoride, polytetrafluoroethylene, or the like.

Examples of the conductant agent include acetylene black, graphite, and carbon fiber. These conductant agents may be used alone or in combination.

Examples of the thickener include an ethylene-vinyl alcohol copolymer, carboxymethyl cellulose, and methyl cellulose.

The dispersant of the positive electrode paste is preferably a solvent that can dissolve the binder.

Examples thereof include N-methyl-2-pyrrolidone, N,N-dimethylformamide, tetrahydrofuran, dimethylacetamide, dimethyl sulfoxide, hexamethyl sulfonamide, tetramethyl urea, acetone, and methyl ethyl ketone. These dispersants may be used alone or in combination.

The positive electrode paste is prepared by blending the binder, conductant agent, and disperser described above, and if necessary, a thickener, and mixing the resulting mixture with a planetary mixer, a homomixer, a pin mixer, a kneader, a homogenizer, or the like.

The positive active material layer is formed by applying the positive electrode paste prepared as above on one or both sides of the positive electrode collector by coating means such as a slit die coater, a reversing roll coater, a lip coater, a blade coater, a knife coater, a gravure coater, or a dip coater, and then drying and flattening the applied paste.

The material for the positive electrode lead 21 is not particularly limited except that the material is should be compatible with the material of the positive plate 11, the type of electrolyte, the material for the battery case 16, the material for the sealing body 17 serving as the positive electrode terminal, etc. The material may be any such material known in the art. Examples thereof include metals such as aluminum and nickel.

The negative plate 12 has one or two negative active material layers formed by applying a negative electrode paste on one or both sides of a negative electrode collector and drying and flattening the applied paste. A portion of the negative plate 12 is formed as a plain part where no negative active material layer is provided. A negative electrode lead 22 for electrically connecting the negative plate 12 to the negative electrode terminal 18 is welded to this plain part.

Examples of the material for the negative electrode collector include aluminum, an aluminum alloy, and copper. The thickness of the negative electrode collector is not particularly limited but is preferably about 10 to 60 μm. The surface of the negative electrode collector may be subjected to lath working or etching treatment.

The negative electrode paste is prepared by blending and mixing a negative active material, a binder, a dispersant, and, if necessary, a conductant agent, a thickener, or the like.

The negative active material is not particularly limited but is preferably a carbon material that can occlude and emit lithium ions by being charged and discharged. Examples thereof include carbon materials obtained by firing organic polymer compounds (e.g., phenolic resin, polyacrylonitrile, cellulose, etc.), carbon materials obtained by firing coke or pitch, artificial graphite, natural graphite, pitch-based carbon fibers, and polyacrylonitrile (PAN)-based carbon fibers. These negative electrode active materials may be used alone or in combination. Examples of the form of the negative electrode active material include fibrous, globose, squamous, and aggregate forms.

The binder, conductant agent, and thickener may be the same as in the related art. In particular, the same binder, conductant agent, and thickener as those used in the positive electrode paste can be used. The dispersant may be the same as that used in the positive electrode paste.

The method of preparing the negative electrode paste and the method of forming the negative electrode active material layers are the same as in the case of using the positive electrode paste and positive active material.

The two separators 13 and 14 are provided to prevent a short-circuit between the positive plate 11 and the negative plate 12. An upper insulating plate 23 for preventing the battery element 15 and the sealing body 17 from directly making physical contact with each other and a lower insulating plate 24 for preventing the battery element 15 and the bottom 20 of the battery case 16 from directly making physical contact with each other are disposed in the battery case 16. Each of the separators 13 and 14 is in contact with both the upper insulating plate 23 and the lower insulating plate 24.

The material for making the separators 13 and 14 is, for example, a polymeric microporous film.

An example of the polymer forming the microporous film is at least one polymer selected from the group consisting of polyethylene, polypropylene, polyvinylidene fluoride, polyvinylidene chloride, polyacrylonitrile, polyacrylamide, polytetrafluoroethylene, polysulfone, polyethersulfone, polycarbonate, polyamide, polyimide, polyether series compounds (e.g., polyethylene oxide, polypropylene oxide, etc.), cellulose series compounds (e.g., carboxymethyl cellulose and hydroxypropyl cellulose), poly(meth)acrylic acid, and poly(meth)acrylates.

The separator may be a multilayer film obtained by stacking microporous films composed of the above-described polymers. Among them, microporous films composed of polyethylene, polypropylene, and polyvinylidene fluoride are preferred. The thickness of the separators 13 and 14 is not particularly limited but is preferably 15 to 30 μm.

The battery case 16 has one end open, and the battery element 15 is housed inside.

The battery case 16 is integrated with and electrically connected to the sealing body 17 at this open end by welding.

Examples of the material for forming the battery case 16 and the sealing body 17 include copper, nickel, stainless steel, nickel-plated steel, aluminum, and aluminum alloys. The battery case 16 after processing may be subjected to plating treatment to increase the anticorrosion property of the battery case 16 and the sealing body 17. The material for forming the battery case 16 and the sealing body 17 is preferably aluminum or an aluminum alloy among the above-described examples in order to make a light-weight prismatic enclosed secondary battery having a high energy density.

The battery case 16 is formed into a desired shape by drawing or drawing and ironing (DI) the above-described material. The material can thus be formed into a battery case.

The battery case 16 and the sealing body 17 can be integrated by a known welding process. An example of the welding process is laser welding.

The battery case 16 and the sealing body 17 are both electrically connected to the positive electrode lead 21 and constitute a positive electrode terminal, which serves as an external terminal of the positive electrode.

The negative electrode terminal 18, which is an external terminal of the negative electrode, is fitted into a through hole in the sealing body 17 via the gasket 19.

Examples of the material for forming the negative electrode terminal 18 include copper, nickel, stainless steel, nickel-plated steel, aluminum, and aluminum alloys.

In the enclosed secondary battery 10 shown in FIG. 1, the above-described gasket of the present invention is used as the gasket 19.

In FIG. 1, the gasket 19 is fitted into the through hole in the sealing body 17 and bonded onto the surface of the sealing body 17 in advance. The negative electrode terminal 18 is attached to the sealing body 17 through the gasket 19 to insulate the sealing body 17 from the negative electrode terminal 18.

In order to bond the gasket 19 onto the surface of the sealing body 17, the gasket 19 having a ring shape is attached along the periphery of the through hole in the sealing body 17 and then pressure-bonded onto the sealing body 17. The pressure bonding treatment may be performed by applying pressure to bond the sealing body 17 onto the gasket 19 with, for example, a caulker and heating the sealing body 17 and the gasket 19 at 300° C. or higher by laser welding.

According to the enclosed secondary battery 10 show in FIG. 1, since the gasket 19 is bonded onto the surface of the sealing body 17, the gasket 19 can absorb deformation caused by thermal expansion and shrinkage of the sealing body 17. Thus, leakage of the electrolyte caused by heat deformation of the sealing body 17, a short circuit between the positive electrode terminal and the negative electrode terminal, and other problems can be highly suppressed.

According to the enclosed secondary battery 10 shown in FIG. 1, since the gasket of the present invention having good heat resistance (in particular, instantaneous heat resistance) is used as the gasket 19, sufficient heat resistance (in particular, instantaneous heat resistance) can be offered against heat during welding of the sealing body 17 to the battery case 16 by a known welding method such as laser welding. Thus, leakage of the electrolyte caused by heat deformation of the sealing body 17, a short circuit between the positive electrode terminal (sealing body 17) and the negative electrode terminal 18, and other problems can be highly suppressed.

In the enclosed secondary battery 10 shown in FIG. 1, in forming the battery element 15 from the electrode plate group having the positive plate 11, the negative plate 12, and the two separators 13 and 14 interposed between the plates, the electrode plate group is rolled up. However, the method of forming the element is not limited to this. The electrode plate group may be folded into a zigzag shape, for example.

In the enclosed secondary battery 10 shown in FIG. 1, the battery case 16 and the sealing body 17 electrically connected to the battery case 16 serve as a positive electrode terminal and a terminal projecting from the through hole in the sealing body 17 serves as a negative electrode terminal. However, the polarity may be reversed.

The enclosed secondary battery 10 may have, for example, the negative electrode terminal 18, i.e., the external terminal of the negative electrode, and the sealing body 17, i.e., the positive electrode terminal serving as an external terminal of the positive electrode, exposed to outside environment by covering the surface of the battery case 16 with an insulating material such as a resin.

In order to prevent the inner pressure of the enclosed secondary battery 10 from excessively rising during charging and discharging, a safety valve 26 may be provided to the sealing body 17, for example.

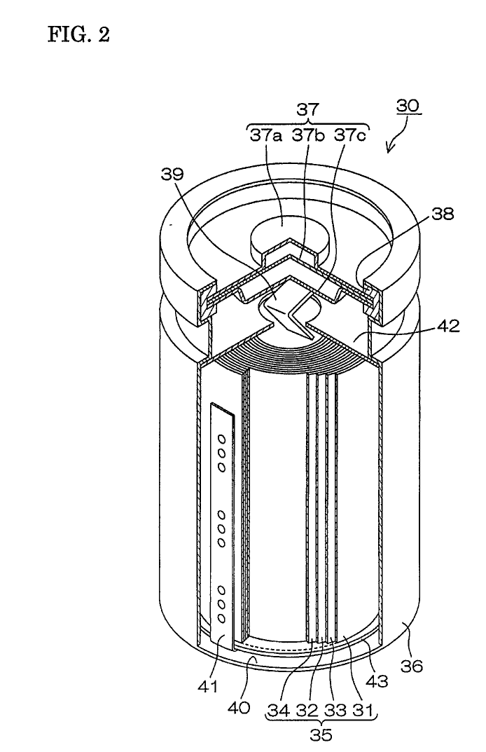

FIG. 2 is a partial cut-away perspective view showing another embodiment of the enclosed secondary battery of the present invention.

An enclosed secondary battery 30 shown in FIG. 2 is a cylindrical enclosed secondary battery and includes a battery element 35 including a electrode plate group having a positive plate 31, a negative plate 32, and two separators 33 and 34 interposed between these plates and an electrolyte (not shown) in which the electrode plate group is immersed; a battery case 36 that houses the battery element 35 and is electrically connected to the negative plate 32 to serve as a negative electrode terminal; a sealing body 37 that seals the opening of the battery case 36 and is electrically connected to the positive plate 31 to serve as a positive electrode terminal; and a gasket 38 interposed between the battery case 36 and the sealing body 37.

As shown in the partial cut-away view of FIG. 2, in the battery element 35, the electrode plate group that includes the positive plate 31, the negative plate 32, and the two separators 33 and 34 is formed by stacking the positive plate 31 and the negative plate 32 with the separator 33 therebetween, stacking the separator 34 on the negative plate 32-side surface to obtain a multilayer structure, and rolling up the multilayer structure with the positive plate 31 facing out and the separator 34 facing in.

The positive plate 31 has one or two positive active material layers formed by applying a positive electrode paste on one or both sides of a positive electrode collector and drying and flattening the applied paste. A portion of the positive plate 31 is formed as a plain part where no positive active material layer is provided. A positive electrode lead 39 for electrically connecting the positive plate 31 to the sealing body 37 is welded to this plain part.

The positive electrode collector, the positive electrode paste, and the positive active material may be the same as those described above.

The negative plate 32 has one or two negative active material layers formed by applying a negative electrode paste on one or both sides of a negative electrode collector and drying and flattening the applied paste. A portion of the negative plate 32 is formed as a plain part where no negative active material layer is provided. A negative electrode lead 41 for electrically connecting the negative plate 32 to a bottom 40 of the battery case 36 is welded to this plain part.

The negative electrode collector, the negative electrode paste, and the negative active material may be the same as those described above.

The two separators 33 and 34 are provided to prevent a short-circuit between the positive plate 31 and the negative plate 32. An upper insulating plate 42 for preventing the battery element 35 and the sealing body 37 from directly making physical contact with each other and a lower insulating plate 43 for preventing the battery element 35 and the bottom 40 of the battery case 36 from directly making physical contact with each other are disposed in the battery case 36. Each of the separators 33 and 34 is in contact with both the upper insulating plate 42 and the lower insulating plate 43.

The materials for forming the separators 33 and 34 is the same as those described above.

The battery case 36 has one part open, and the battery element 35 is housed inside. The opening of the battery case 36 is sealed with the sealing body 37.

The battery case 36 is electrically connected to the negative plate 32 via the negative electrode lead 41 to serve as an external connecting terminal (negative electrode terminal) of the negative electrode.

The battery case 36 and the sealing body 37 are sealed with the gasket 38.

The material for forming the battery case 36 is the same as those described above.

The method of forming the battery case 36 is also the same as above.

The sealing body 37 has a cap 37a, a valve 37b for preventing an abnormal pressure increase inside the battery case 36, and a plate 37c for contacting the positive electrode lead 39.

The sealing body 37 is electrically connected to the positive plate 31 via the positive electrode lead 39. Among these components, the cap 37a serves as an external connecting terminal (positive electrode terminal) of the positive electrode.

The materials for forming the cap 37a, the valve 37b, and the plate 37c are the same as those for forming the sealing body 17 of the enclosed secondary battery 10 shown in FIG. 1.

In the enclosed secondary battery 30 shown in FIG. 2, the above-described gasket of the present invention is used as the gasket 38.

In FIG. 2, the gasket 38 in a ring shape is pressure-bonded to the vicinity of the opening of the inner peripheral surface of the battery case 36 in advance. Since the gasket 38 is interposed between the battery case 36 and the sealing body 37, the sealing body 37 serving as the positive electrode terminal is insulated from the battery case 36 serving as the negative electrode terminal.

Note that for the enclosed secondary battery 30 shown in FIG. 2, the same pressure-bonding treatment for bonding the gasket 19 to the surface of the sealing body 17 of the enclosed secondary battery 10 shown in FIG. 1 may be effected to bond the gasket 38 onto the inner peripheral surface of the battery case 36.

According to the enclosed secondary battery 30 show in FIG. 2, since the gasket 38 is bonded onto the inner peripheral surface of the battery case 36, the gasket 38 can absorb deformation caused by thermal expansion and shrinkage of the battery case 36. Thus, leakage of the electrolyte caused by heat deformation of the battery case 36, a short circuit between the positive electrode terminal and the negative electrode terminal, and other problems can be highly suppressed.

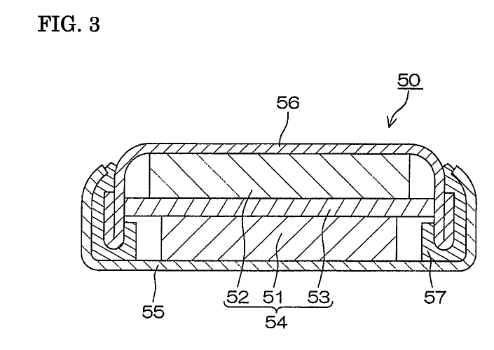

FIG. 3 is a cross-sectional view showing yet another embodiment of the enclosed secondary battery of the present invention.

An enclosed secondary battery 50 shown in FIG. 3 is a button type enclosed secondary battery and includes a battery element 54 including a electrode plate group having a positive plate 51, a negative plate 52, and a separator 53 interposed between the positive plate 51 and the negative plate 52 and an electrolyte (not shown) in which the electrode plate group is immersed; a battery case 55 that houses the battery element 54 and is electrically connected to the positive plate 51 to serve as a positive electrode terminal; a sealing body 56 that seals the opening of the battery case 55 and is electrically connected to the negative plate 52 to serve as a negative electrode terminal; and a gasket 57 interposed between the battery case 55 and the sealing body 56.

The positive plate 51 has two positive active material layers formed by applying a positive electrode paste on both sides of a positive electrode collector and drying and flattening the applied paste. The positive electrode collector, the positive electrode paste, and the positive active material may be the same as those described above.

The negative plate 52 has one or two negative active material layers formed by applying a negative electrode paste on one or both sides of a negative electrode collector and drying and flattening the applied paste. The negative electrode collector, the negative electrode paste, and the negative active material may be the same as those described above.

The separator 53 is provided to prevent a short circuit between the positive plate 51 and the negative plate 52. The material for forming the separator 53 is the same as those described above.

The battery case 55 has one part open, and the battery element 54 is housed inside.

The battery case 55 has the sealing body 56 at the opening, and the battery case 55 and the sealing body 56 are sealed with the gasket 57.

The material for forming the battery case 55 is the same as those described above. The method of forming the battery case 55 is also the same as above.

The material for forming the sealing body 56 is the same as those for forming the sealing body 17 of the enclosed secondary battery 10 shown in FIG. 1.

In the enclosed secondary battery 50 shown in FIG. 3, the above-described gasket of the present invention is used as the gasket 57.

In FIG. 3, the gasket 57 in a ring shape is pressure-bonded to the vicinity of the opening of the inner peripheral surface of the battery case 55 in advance. Since the gasket 57 is interposed between the battery case 55 and the sealing body 56, the battery case 55 serving as the positive electrode terminal is insulated from the sealing body 56 serving as the negative electrode terminal.

Note that for the enclosed secondary battery 50 shown in FIG. 3, the same pressure-bonding treatment for bonding the gasket 19 to the surface of the sealing body 17 of the enclosed secondary battery 10 shown in FIG. 1 may be effected to bond the gasket 57 onto the inner peripheral surface of the battery case 55.

According to the enclosed secondary battery 50 show in FIG. 3, since the gasket 57 is bonded onto the surface of the battery case 55, the gasket 57 can absorb deformation caused by thermal expansion and shrinkage of the battery case 55. Thus, leakage of the electrolyte caused by heat deformation of the battery case 55, a short circuit between the positive electrode terminal and the negative electrode terminal, and other problems can be highly suppressed.

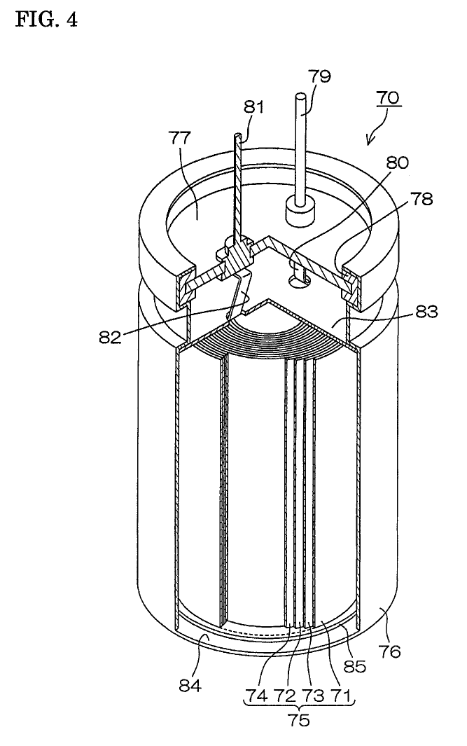

FIG. 4 is a partial cut-away perspective view showing one embodiment of the electrolytic capacitor of the present invention.

An electrolytic capacitor 70 shown in FIG. 4 is a snap-in type electrolytic capacitor and includes a capacitor element 75 including an electrode foil group having a positive electrode foil 71, a negative electrode foil 72, and two separators 73 and 74 interposed between these foils and an electrolyte (not shown) in which the electrode foil group is immersed; an exterior body 76 having an opening for housing the capacitor element 75; a sealing body 77 for sealing the opening of the exterior body 76; and a gasket 78 for hermetically sealing between the exterior body 76 and the sealing body 77.

As shown by partial cut-away view of FIG. 4, in the capacitor element 75, the electrode foil group that includes the positive electrode foil 71, the negative electrode foil 72, and the two separators 73 and 74 is formed by stacking the positive electrode foil 71 and the negative electrode foil 72 with the separator 73 therebetween, stacking the separator 74 on the negative electrode foil 72-side surface to obtain a multilayer structure, and rolling up the multilayer structure with the positive electrode foil 71 facing out and the separator 74 facing in.

The positive electrode foil 71 has one or two positive active material layers formed by applying a positive electrode paste on one or both sides of a positive electrode collector and drying and flattening the applied paste. A portion of the positive electrode foil 71 is formed as a plain part where no positive active material layer is formed. A positive electrode lead 80 is welded to the plain part and is electrically connected to a positive electrode terminal 79. According to this structure, the positive electrode terminal 79 is electrically connected to the positive electrode foil 71.

The positive electrode collector, the positive electrode paste, and the positive active material may be the same as those described above.

The negative electrode foil 72 has one or two negative active material layers formed by applying a negative electrode paste on one or both sides of a negative electrode collector and drying and flattening the applied paste. A portion of the negative electrode foil 72 is formed as a plain part where no negative active material layer is formed. A negative electrode lead 82 is welded to the plain part and is electrically connected to a negative electrode terminal 81. According to this structure, the negative electrode terminal 81 is electrically connected to the negative electrode foil 72.

The negative electrode collector, the negative electrode paste, and the negative active material may be the same as those described above.

The two separators 73 and 74 are provided to prevent a short-circuit between the positive electrode foil 71 and the negative electrode foil 72. The capacitor element 75, an upper insulating plate 83 for preventing the positive electrode terminal 79 and the negative electrode terminal 81 from directly contacting each other, and a lower insulating plate 85 for preventing the capacitor element 75 and a bottom 84 of the exterior body 76 from directly contacting each other are disposed inside the exterior body 76. Each of the separators 73 and 74 is in contact with both the upper insulating plate 83 and the lower insulating plate 85.

The material for forming the separators 73 and 74 is the same as those described above.

The battery case 76 has one part open, and the capacitor element 75 is housed inside.

The battery case 76 has the sealing body 77 at the opening, and the exterior body 76 and the sealing body 77 are sealed with the gasket 78.

The material for forming the exterior body 76 is the same as that for forming the battery case 16 of the enclosed secondary battery 10 shown in FIG. 1. The method for forming the exterior body 76 is also the same as above.

In the electrolytic capacitor 70 shown in FIG. 4, the above-described gasket of the present invention is used as the gasket 78.

In FIG. 4, the gasket 78 in a ring shape is pressure-bonded to the vicinity of the opening of the inner peripheral surface of the exterior body 76 in advance. Since the gasket 78 is interposed between the exterior body 76 and the sealing body 77, the electrolyte is prevented from leaking from between the exterior body 76 and the sealing body 77.

Note that for the electrolytic capacitor 70 shown in FIG. 4, the same pressure-bonding treatment for bonding the gasket 19 to the surface of the sealing body 17 of the enclosed secondary battery 10 shown in FIG. 1 may be effected to bond the gasket 78 onto the inner peripheral surface of the exterior body 76.

According to the electrolytic capacitor 70 described above, since the gasket 78 is bonded onto the surface of the exterior body 76, the gasket 78 can absorb deformation caused by thermal expansion and shrinkage of the exterior body 76. Thus, leakage of the electrolyte caused by thermal deformation of the exterior body 76 can be highly suppressed.

The gasket of the present invention can be provided as an insert product integral with a conductive substrate such as an electrode by insert molding, or as an outsert product integrated with a molded product such as a conductive substrate by outsert molding.

The gasket of the present invention may be provided as an electrode component, in which a gasket is molded as an integrated product with a rigid member (e.g., substrate) and a resin plating is effected on a surface of the product in a gasket portion to insulate the gasket from the rigid member.

In the gasket of the present invention, the ionomers are cross-linked and swelling caused by the electrolyte can be suppressed thereby, as described above. Compared with uncrosslinked ionomers, cross-linked ionomers have low adhesiveness to a metal plate but maintains sufficient bonding property because the ionic functional group content in the ionomers is high. Thus, the gasket of the present invention is suitable for use in a component in which a thin-layered gasket is secured on a surface of a very small conductor (lead wire) (e.g., “TAB LEAD” (trade name), a lead wire for Li-ion battery, produced by SUMITOMO ELECTRIC INDUSTRIES, LTD.,) or the like. In particular, the gasket of the present invention not only has good sealing property (sealability), but also renders it unnecessary to interpose an adhesive layer in securing a thin layered gasket on the surface of the conductor (lead wire) since the swelling caused by the electrolyte is suppressed and the adhesiveness to the metal plate is maintained. Thus, the thickness of the layer or film of the gasket can be further reduced, and an increase in battery capacity, size reduction of batteries, and reduction of manufacturing cost of batteries are thereby achieved.

Although the invention is described above by way of embodiments exemplifying the invention, the embodiments are merely examples and should not be considered to be limiting. Modifications of the present invention obvious to those skilled in the art pertaining to the technical field of the present invention are included in the scope of the claims of this application.

### EXAMPLES

Next, the present invention is described by way of Examples. Examples described below do not limit the scope of the present invention.

The components used in Examples and Comparative Examples are as follows.

Ethylene-acrylate copolymer: ion species: zinc, serial number “1706” produced by DU PONT-MITSUI POLYCHEMICALS CO., LTD. Maleic acid-modified ethylene tetrafluoride-ethylene copolymer (maleic acid-modified ETFE): ethylene tetrafluoride-ethylene copolymer (ETFE; trade name “NEOFLON ETFE” produced by DAIKIN INDUSTRIES, LTD.) modified with maleic acid Maleic anhydride-modified polypropylene (maleic anhydride-modified PP): trade name “ADMER (registered trademark) QF551” produced by MITSUI CHEMICALS, INC. High-density polyethylene: product name “HI-ZEX (registered trademark) 5305” produced by Prime Polymer Co., Ltd. Ethylene tetrafluoride-ethylene copolymer (ETFE): trade name “NEOFLON ETFE” produced by DAIKIN INDUSTRIES, LTD.

Cross-linking auxiliary: triallyl isocyanate (TAIL) •Filler: silica

### Examples 1 to 5 and Comparative Examples 1 to 3

(1) Preparation of Gasket Samples

For each of Examples and Comparative Examples, components shown in Table were mixed, and the resulting resin composition was mixed in a twin-screw extruder and injection-molded to form a plate 50 mm in length, 60 mm in width, and 2 mm in thickness. The plate was irradiated with an electron beam at an exposure dose of 240 kGy to obtain a cross-linked sample.

To determine the dynamic viscoelasticity of the sample (cross-linked sample), the tensile storage elastic modulus E′ (MPa) of the sample at a frequency of 10 Hz and temperature of 350° C. was measured with a dynamic mechanical spectrometer (DMS).

The sample of the size described above desirably has a tensile storage elastic modulus E′ of 1.0 MPa or more at a temperature of 350° C. and frequency of 10 Hz.

(2) Evaluation of Physical Properties of Gasket Samples

Next, the sample (cross-linked sample) obtained in (1) was laminated on a surface of an aluminum foil (15 mm in width and 0.1 mm in thickness) and pressed for 10 seconds at 300° C. and 10 MPa.

The resulting composite (15 mm in width) of the sample (cross-linked sample) and the aluminum foil was used to measure the peel strength (N/15 mm) of the sample (cross-linked sample) and the aluminum foil. The results are shown in Table below.

The peel strength (N/15 mm) of the sample (cross-linked sample) and the aluminum foil was measured according to Japanese Industrial Standards (JIS) K 6256:₁₉₉₉ “Adhesion testing methods for rubber, vulcanized or thermoplastic”.

Among the samples (cross-linked samples), those (cross-linked samples) prepared from resin compositions of Example 1 and Comparative Example 1 were analyzed to determine a residual elastic modulus at a compressibility of 50% (50% residual elastic modulus). The results are shown in Table below.

The 50% residual elastic modulus is a percentage of an increase in thickness observed when a resin constituting a sample compressed to 50% in terms of volume is released from compression, relative to the thickness of the sample in a compressed state.

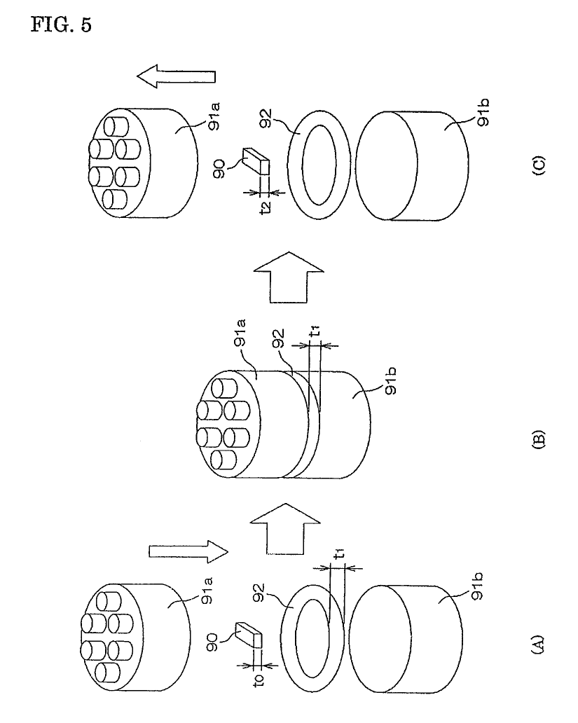

For example, the 50% residual elastic modulus is, in particular, measured as shown in Part (a) to Part (c) of FIG. 5. First, referring to Part (a) and Part (b) of FIG. 5, a test piece 90 (thickness t₀) composed of a resin constituting the above-described sample is compressed to a thickness t₁ of a shim 92 with an upper die 91a and a lower die 91b. The test piece 90 in the state shown in Part (b) of FIG. 5 is then left standing in an environment at 100° C. for two days, and then, as shown in Part (c) of FIG. 5, the compression is released and the thickness t₂ of the test piece 90 after released from the compression state is measured. The residual elastic modulus M (%) is determined from equation (1) below from the thickness t₁ of the test piece 90 under compression and the thickness t₂ after being released from compression. The compressibility C (%) of the test piece 90 in a compressed state is determined by equation (2) below.

M=((t₂−t₁)/t₁)×100 (1)

C=((t₀−t₁)/t₀)×100 (2)

(3) Preparation of Enclosed Secondary Battery and Evaluation of its Physical Properties

A prismatic enclosed secondary battery 10 shown in FIG. 1 was prepared as follows.

LiCoO₂ (positive active material), carbon black (conductant agent), and an aqueous dispersion of polyethylene tetrafluoride (binder) were kneaded and dispersed at a solid content ratio of 100:3:10, and the resulting paste was applied on both sides of a collector (30 μm in thickness) formed of an aluminum foil by a doctor blade method so that the thickness was about 230 μm, and dried. The coating film composed of the paste was flattened to a thickness of 180 μm and cut into predetermined dimensions to obtain a positive plate 11.

A carbonaceous material as a main material and a styrene-butadiene-rubber series binder were kneaded and dispersed at a weight ratio of 100:5, and the resulting paste was applied on both sides of a collector (20 μm in thickness) formed of a copper foil by a doctor blade method so that the thickness was about 230 μm, and dried. The coating film of the paste was flattened to a thickness of 180 μm and cut into predetermined dimensions to obtain a negative plate 12.

For each of Examples and Comparative Examples, a resin composition prepared by blending components indicated in Table was mixed with a twin screw extruder and injection-molded into a ring shape having a substantially letter-U-shaped cross-section. The resulting ring-shaped resin composition was irradiated with an electron beam at an exposure dose of 100 kGy to obtain a cross-linked gasket 19.

Gaskets 19 composed of resin compositions of Examples and Comparative Examples were each fitted into a peripheral portion 25 of an insertion hole for negative electrode terminal 18, the insertion hole being formed in a sealing body 17 composed of an aluminum alloy. A negative electrode terminal 18 was inserted into the insertion hole for the negative electrode terminal 18, and a leg 27 of the negative electrode terminal 18 was bent along the gasket 19 (refer to FIG. 1). Subsequently, pressing was conducted for 10 seconds at 200° C. and 10 MPa to bond the gasket 19 to the sealing body 17 and the negative electrode terminal 18.

The positive plate 11 and the negative plate 12 were wound with two separators (25 μm in thickness, shape retention temperature 128° C.) 13 and 14 formed of microporous films of polyethylene resin into a flat shape, and pressing process was conducted to obtain a electrode plate group having a substantially elliptical cross-sectional shape. A battery element 15 including the electrode plate group and an electrolyte (a solution of 1 mol/L of lithium hexafluorophosphate in a mixed solvent containing ethylene carbonate and diethyl carbonate at a molar ratio of 1:3) in which the electrode set was immersed was housed in a prismatic battery case 16 composed of an aluminum alloy, and sealed with a sealing body 17. The gasket 19 was adjusted such that its compressibility is 50% when caulked between the sealing body 17 and the negative electrode terminal 18.

The resulting prismatic enclosed secondary battery 10 had an outer thickness of 5.3 mm, an outer width of 30 mm, and an outer height of 48 mm, and the battery capacity was 800 mAh.

Next, ten enclosed secondary batteries 10 incorporating the gaskets 19 composed of resin composition of Examples and Comparative Examples were used for each of Examples and Comparative Examples to run 100 cycles of charge/discharge operation. Subsequently, the enclosed secondary batteries 10 were observed from outside with naked eye, the number of batteries with electrolyte leakage was counted, and the status of electrolyte leakage after 100 cycles was evaluated according to the following criteria.

AA: No electrolyte leakage was observed. The electrolyte leakage preventive effects were particularly notable.

A: Leakage was slightly observed but the electrolyte leakage preventive effects were good and sufficient for practical use.

B: Electrolyte leakage was observed. The electrolyte leakage preventive effects were not sufficient for practical use.

C: Extensive leakage was observed, and the electrolyte leakage preventive effects were not sufficient.

The results are shown in Table below.

TABLE

| | Examples | | Comparative | | Comparative | Examples | | Comparative |
|---|---|---|---|---|---|---|---|---|
| | 1 | 2 | Example 1 | Example 3 | Example 2 | 4 | 5 | Example 3 |
| <Gasket composition> | | | | | | | | |
| Ionomer | | | | | | | | |
| Ethylene-acrylate copolymer | 100 | 100 | — | 100 | — | — | — | — |
| Maleic acid-modified ETFE | — | — | — | — | — | 100 | — | — |
| Maleic anhydride-modified PP | — | — | — | — | — | — | 100 | — |
| High-density polyethylene | — | — | 100 | — | 100 | — | — | — |
| Ethylene tetrafluoride- | — | — | — | — | — | — | — | 100 |
| ethylene copolymer (ETFE) | | | | | | | | |
| Cross-linking auxiliary TAIC | — | 2 | 2 | 2 | 2 | 2 | 2 | — |
| Filler Silica | — | — | — | 50 | 50 | — | — | — |
| <Electron beam exposure dose> (kGy) | 240 | 240 | 240 | 240 | 240 | 240 | 240 | 240 |
| <Evaluation of physical properties> | | | | | | | | |
| Tensile storage elastic modulus E′ (MPa) | 1.2 | 2.0 | 0.50 | 0.70 | 6.0 | 7.0 | 3.0 | — |
| Debonding strength (N/15 mm) | 5 | 4 | <0.1 | 3 | <0.1 | 1 | 0.8 | <0.1 |
| Electrolyte leakage after 100 cycles | 0/10 | 0/10 | 10/10 C | 0/10 | 5/10 B | 0/10 | 1/10 A | 3/10 B |
| | AA | AA | | AA | | AA | | |
| Residual elastic modulus (compressibility 50%) | 1.5% | — | 7.7% | — | — | — | — | — |

In Table, the tensile storage elastic modulus E′ is the value observed at a temperature of 350° C. and a frequency of 10 Hz.

As shown in Table, in Examples 1 to 5, since the gasket contained a cross-linked ionomer, the tensile storage elastic modulus at high temperature was high and the peel strength to the aluminum foil was satisfactory. The enclosed secondary batteries incorporating the gaskets of Examples 1 to 5 did not suffer electrolyte leakage even after 100 cycles of charging and discharging.

In contrast, Comparative Examples 1 to 3 incorporating gaskets not containing cross-linked ionomers exhibited low tensile storage elastic modulus at high temperature and insufficient peel strength to the aluminum foil. Some of the enclosed secondary batteries incorporating the gaskets of Comparative Examples 1 to 3 suffered electrolyte leakage after 100 cycles of charging and discharging.

In the enclosed secondary batteries with gaskets 19 composed of a resin composition of Example 1, the 50% residual elastic modulus of the gaskets was below 4%. In general, in using a gasket in an enclosed secondary battery, the 50% residual elastic modulus is preferably 4 to 25% from the viewpoints of leakage resistance and shape retention temperature of the gasket (refer to Patent Document 1). However, in the enclosed secondary battery of Example 1, since the gasket was composed of a cross-linked ionomer and bonded to the positive or negative electrode terminal by heating and compressing, sealing and insulation between the positive and negative electrode terminals were achieved despite the gasket's residual elastic modulus below 4.0%, thereby preventing leakage of the electrolyte. In contrast, in the enclosed secondary battery of Comparative Example 1, since the gasket was not composed of a cross-linked ionomer and had low peel strength and tensile storage elastic modulus at high temperature, the sealing and insulation between the positive and negative electrode terminals were not achieved although the residual elastic modulus of the gasket was more than 4.0%. Thus, the prevention of the electrolyte leakage was insufficient.

### INDUSTRIAL APPLICABILITY

According to the gasket of the present invention and the enclosed secondary battery and electrolytic capacitor incorporating the gaskets, good heat resistance (in particular, instantaneous heat resistance) and good electrolytic resistance and insulating property can be exhibited due to the gaskets. Good sealing property can be exhibited despite the small size and thickness, and thus the size and thickness of the enclosed secondary battery and the electrolytic capacitor can be further reduced. Thus, the industrial applicability is significantly high.

1-5. (canceled)

6. A gasket comprising a cross-linked ionomer.

7. The gasket according to claim 6, wherein the ionomer is a polyolefin series ionomer or a fluorine series ionomer.

8. The gasket according to claim 6, wherein a tensile storage elastic modulus E′ measured at a temperature of 350° C. and a frequency of 10 Hz is 1 MPa or more and a peel strength when press-bonded to a surface of a metal plate at 200° C. to 400° C. and 0.1 to 10 MPa is 0.1 N/15 mm or more.

9. The gasket according to claim 7, wherein a tensile storage elastic modulus E′ measured at a temperature of 350° C. and a frequency of 10 Hz is 1 MPa or more and a peel strength when press-bonded to a surface of a metal plate at 200° C. to 400° C. and 0.1 to 10 MPa is 0.1 N/15 mm or more.

10. An enclosed secondary battery comprising:
a battery element that includes a positive plate, a negative plate, and a separator interposed between the positive plate and the negative plate, and a positive electrode terminal electrically connected to the positive plate;
a negative electrode terminal electrically connected to the negative plate, and a gasket for insulating the positive electrode terminal from the negative electrode terminal, wherein the gasket is the gasket according to claim 6 and is bonded onto the positive electrode terminal or the negative electrode terminal by applying heat and pressure.

11. An electrolytic capacitor comprising a capacitor element that includes a positive electrode foil, a negative electrode foil, and a separator interposed between the positive electrode foil and the negative electrode foil, an exterior body having an opening for housing the capacitor element, a sealing body for sealing the opening of the exterior body, and a gasket for sealing between the exterior body and the sealing body, wherein the gasket is the gasket according to claim 6 and is bonded onto any one of an inner surface of the exterior body and a surface of the sealing body by applying heat and pressure.
